(19) United States
(12) Patent Application Publication
(10) Pub. No.: US 2023/0280886 A1
(43) Pub. Date: Sep. 7, 2023

(54) PERSONALIZED NOTIFICATION SYSTEM

(71) Applicant: Vernon Lomax Bartee, Baltimore, MD (US)

(72) Inventor: Vernon Lomax Bartee, Baltimore, MD (US)

(21) Appl. No.: 18/178,839

(22) Filed: Mar. 6, 2023

Related U.S. Application Data
(60) Provisional application No. 63/316,743, filed on Mar. 4, 2022.

(51) Int. Cl. G06F 3/0484; H04N 5/76

(52) U.S. Cl. CPC G06F 3/0484; H04N 5/76; H04N 19/40

(57) ABSTRACT

A personalized notification system includes a processor, and a memory comprising computing device-executable instructions that, when executed by the processor, cause the processor to implement: a communications interface for accessing a personalized notification platform over a network; a user interface for displaying and interacting with the personalized platform; a generation module for generating a video recording comprising at least one identified event and a recipient; a calendar module for selecting a date for the recipient to receive the video recording; and a notification module for generating a notification of the identified event comprising the video recording.

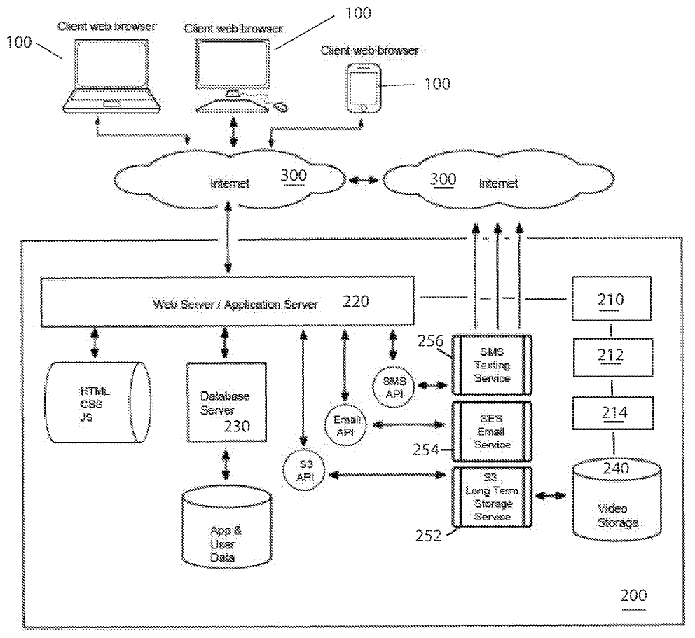

### CROSS-REFERENCE TO RELATED APPLICATION

This application claims the benefit of priority of U.S. provisional application No. 63/316,743 filed 4 Mar. 2022 the contents of which are herein incorporated by reference.

### BACKGROUND OF THE INVENTION

This invention relates generally to computing systems, and more particularly, to a personalized notification system that includes a video message retrievably stored on a platform for an identified event and an associated recipient and a technique for transmitting the video message to the recipient on a date associated with the identified event.

Having people forget important events or special occasions can be heartbreaking, since all we have at the end are our memories. More embarrassing is forgetting to remind people in the first place.

Current notification systems do not work well because there are too many steps a user must remember to use them each time that there is a need.

A need exists for a set-and-forget personalized notification system enabling one can digitally save a recorded video message on a systemic server/app, wherein the recorded video message can be programmatically sent to someone as a notification or a reminder of the event or occasion, thereby there would no reason to miss these life changing moments again. The present invention takes the stress off the user and puts it in the care of the systemic platform; all a user of the present invention must do is remember uploading memorabilia, and a small amount of information. The present invention is easier to use than the prior art because all a user must do is set it up once for those repeated occasions and forget it—the systemic platform will do the rest.

### SUMMARY OF THE INVENTION

In one aspect of the present invention, a personalized notification system includes the following: a processor, and a memory comprising computing device-executable instructions that, when executed by the processor, cause the processor to implement: a communications interface for accessing a personalized notification platform over a network; a user interface for displaying and interacting with the personalized platform; a generation module for generating a video recording comprising at least one identified event and a recipient; a calendar module for selecting a date for the recipient to receive the video recording; and a notification module for generating a notification of the identified event comprising the video recording.

These and other features, aspects and advantages of the present invention will become better understood with reference to the following drawings, description, and claims.

### BRIEF DESCRIPTION OF THE DRAWINGS

SOLE FIGURE is a schematic view of an exemplary embodiment of a web application architecture of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Referring to the SOLE FIGURE, the present invention may include a system for personalized notifications. The system includes at least one computing device 100 having a processor and a memory. The memory includes software in the form of computing device-executable instructions that, when executed by the processor, cause the processor to implement: a communications interface, a user interface, and a personalized notifications platform 200. The personalized notifications platform 200 includes, but is not limited to, a video generation module 210, a calendar module 212, and a notification module 214.

The web application architecture for the personalized notifications platform 200 is provided in the SOLE FIGURE.

The overall architecture requires several technology layers (hardware and software). These are described below, and many are services offered by Amazon Web Services (AWS®), the cloud computing division of Amazon. The users will access the personalized notifications platform 200 using the client web browser on their chosen device 100. The web application of the personalized notifications platform 200 supports access from mobile phones, tablets, laptops, and desktop computers 100. Users will connect over the Internet or other computer network 300 to the personalized notifications platform 200.

The Application Web Server 220 may run on an instance of AWS Lightsail™ These are lightweight, low-cost web servers for a variety of uses.

The Web Application itself is written in a combination of computer languages. The front end (client side) uses HTML, CSS, and JavaScript. The backend (server side) is implemented in the PHP programming language, version 7. These files, and other assets (such as images) will be stored on the local hard drive of the Web Server.

Database 230 may retrievably store persistent data (such as user accounts, and information about every video clip uploaded and sent) that may be maintained in a MySQL database. For the systemic Web App, a separate computer instance is used to serve as a dedicated database server. That database server has its own local hard drive in which it stores the data for the application. By moving the database off the web server, the present invention ensures that database queries do not interfere with the performance of the web application itself.

Video Conversion and Storage 240 is configured so that video clips are uploaded and are transcoded (converted) into different formats and sizes so that they can be viewed on a variety of screen sizes. Initially, clips are transcoded to three sizes. The transcoding step is very CPU intensive and would interfere with the operation of the web server. Therefore, another Lightsail™ server is used for the sole purpose of running the transcoding. The technology used for the transcoding is called ffmpeg.

Once the video clips are transcoded, they are stored in a Long Term Storage service Module 252. For this, the AWS Simple Storage Service (S3) is used. It provides unlimited storage, with very high reliability, at very low prices per GB of data. It too is a pay-for-what-you-use usage model.

Email Notification 254 is configured so that notifications are sent to users to inform them when they receive a new video message. Initially, email is used for these notifications (unless and until the user updates their preferences in the My Account page). The emails are sent using a bulk email service. For this the AWS Simple

Email Service (SES) is used. It provides very low cost per message, and high reliability.

The SMS (Text) Notification Module 256 is configured so that if the user chooses to provide a mobile phone number during the registration process and chooses to opt-in to receiving text messages from the systemic platform 200, the notifications can be sent by text message. For this, the Twilio SMS Notification Service is used. It offers a solid, low-cost platform and government compliance for the regulated space of sending business text messages.

Basically, the architecture could be replaced with any other web application architecture (e.g, Iemp, Ilap, Mern, Mean, Wamp), the components still would need to communicate using standard protocols. Then the custom computer programming to implement the core logic of the IMA application would then need to be implemented. All the elements are necessary.

The systemic platform 200 and its systemic components communicate using an internationally established standard communication protocol (TCP/IP, SSL, HTTP/S).

The systemic platform 200 may prompt a unique user to register and then prompt the user through the following systemic components/steps:

Component 1: Select send a notification message.

Component 2: Select an occasion for which you would like to leave a message.

Component 3: Record a video message via the video generation module 210.

Component 4: Select your video message to upload to the app.

Component 5: Select the recipient from a sent list, or enter a new recipient, to whom a video link is to be sent.

Component 6: Select when you want the systemic platform 200 to send the video (now or a future date), using the calendar module 212.

Component 7: Through the calendar module 212, a user is prompted to select how often you want the video link to be sent to the recipient (one time, once a month, or the same date every year).

Component 8: Prompting a user to press Upload and Send to start the process through the notification module 214. A confirmation will be sent to the user, to let them know when the message was successfully sent.

Component 9: A confirmation will be sent to you every time a video is sent and viewed, letting you know that it was successfully done.

The personalized notification platform 200 may include a standalone software program. The standalone program may include a plurality of different users that create profiles with identifying pictures, videos, personal data, and the like. Alternatively, the personalized notification platform 200 may include application programming interface (API) plugins for texting, emailing, and video storage functionality that agnostically integrates such features into the systemic platform 200.

In certain embodiments, the network may refer to any interconnecting system capable of transmitting audio, video, signals, data, messages, or any combination of the preceding. The network may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

The server and the computer of the present invention may each include computing systems. This disclosure contemplates any suitable number of computing systems. This disclosure contemplates the computing system taking any suitable physical form. As example and not by way of limitation, the computing system may be a virtual machine (VM), an embedded computing system, a system-on-chip (SOC), a single-board computing system (SBC) (e.g., a computer-on-module (COM) or system-on-module (SOM)), a desktop computing system, a laptop or notebook computing system, a smart phone, an interactive kiosk, a mainframe, a mesh of computing systems, a server, an application server, or a combination of two or more of these. Where appropriate, the computing systems may include one or more computing systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example, and not by way of limitation, one or more computing systems may perform in real time or in batch mode one or more steps of one or more methods described or illustrated herein. One or more computing systems may perform at different times or at different locations one or more steps of one or more methods described or illustrated herein, where appropriate.

In some embodiments, the computing systems may execute any suitable operating system such as IBM's zSeries/Operating System (z/OS), MS-DOS, PC-DOS, Mac-OS, Windows, Unix, OpenVMS, an operating system based on Linux, or any other appropriate operating system, including future operating systems. In some embodiments, the computing systems may be a web server running web server applications such as Apache, Microsoft's Internet Information Server™, and the like.

In particular embodiments, the computing systems include a processor, a memory, a user interface and a communication interface. In particular embodiments, the processor includes hardware for executing instructions, such as those making up a computer program. The memory includes main memory for storing instructions such as computer program(s) for the processor to execute, or data for processor to operate on. The memory may include mass storage for data and instructions such as the computer program. As an example and not by way of limitation, the memory may include an HDD, a floppy disk drive, flash memory, an optical disc, a magneto-optical disc, magnetic tape, a Universal Serial Bus (USB) drive, a solid-state drive (SSD), or a combination of two or more of these. The memory may include removable or non-removable (or fixed) media, where appropriate. The memory may be internal or external to computing system, where appropriate. In particular embodiments, the memory is non-volatile, solid-state memory.

The user interface may include hardware, software, or both providing one or more interfaces for communication between a person and the computer systems. As an example, and not by way of limitation, a user interface device may include a keyboard, keypad, microphone, monitor, mouse, printer, scanner, speaker, still camera, stylus, tablet, touchscreen, trackball, video camera, another suitable user interface or a combination of two or more of these. A user interface may include one or more sensors. This disclosure contemplates any suitable user interface.

The communication interface includes hardware, software, or both providing one or more interfaces for communication (e.g., packet-based communication) between the computing systems over the network. As an example, and not by way of limitation, the communication interface may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface. As an example, and not by way of limitation, the computing systems may communicate with an ad hoc network, a personal area network (PAN), a local area network (LAN), a wide area network (WAN), a metropolitan area network (MAN), or one or more portions of the

Internet or a combination of two or more of these. One or more portions of one or more of these networks may be wired or wireless. As an example, the computing systems may communicate with a wireless PAN (WPAN) (e.g., a BLUETOOTH WPAN), a WI-FI network, a WI-MAX network, a cellular telephone network (e.g., a Global System for Mobile Communications (GSM) network), or other suitable wireless network or a combination of two or more of these. The computing systems may include any suitable communication interface for any of these networks, where appropriate.

It should be understood, of course, that the foregoing relates to exemplary embodiments of the invention and that modifications may be made without departing from the spirit and scope of the present invention.

What is claimed is:

1. A personalized notification system comprising:
a processor, and
a memory comprising computing device-executable instructions that, when executed by the processor, cause the processor to implement:
a communications interface for accessing a personalized notification platform over a network;
a user interface for displaying and interacting with the personalized platform;
a generation module for generating a video recording comprising at least one identified event and a recipient;
a calendar module for selecting a date for the recipient to receive the video recording; and
a notification module for generating a notification of the identified event comprising the video recording.

2. The personalized notification system of claim 1, wherein each video recording is transcoded to three sizes wherein a separate cloud service, separate from the personalized notification platform is used for the sole purpose of running the transcoding.

3. The personalized notification system of claim 1, wherein the processor is caused to implement prompting a user to select send the notification.

4. The personalized notification system of claim 1, wherein the processor is caused to implement prompting a user to select the identified event.

5. The personalized notification system of claim 1, wherein the processor is caused to implement prompting a user to record the video recording via the video generation module.

6. The personalized notification system of claim 1, wherein the processor is caused to implement prompting a user to select a pre-existing video message to upload to the consolidation module.

7. The personalized notification system of claim 1, wherein the processor is caused to implement prompting a user to select the recipient from a sent list, or enter a new recipient, to whom a video link is to be sent.

8. The personalized notification system of claim 1, wherein the processor is caused to implement prompting a user to select how often you want the video recording to be sent to the recipient.

9. The personalized notification system of claim 1, wherein the processor is caused to implement prompting a user to select a confirmation to be sent to the user when the notification is successfully sent.

10. The personalized notification system of claim 1, wherein the processor is caused to implement prompting a user to select a confirmation will be sent to you every time the video recording is sent and viewed.
